(19) United States
(12) Patent Application Publication
(10) Pub. No.: US 2025/0278910 A1
(43) Pub. Date: Sep. 4, 2025

(54) TRY-ON IMAGE GENERATION METHOD, SYSTEM, AND MODEL TRAINING METHOD

(71) Applicant: Alibaba Singapore Holding Private Limited, Singapore (SG)

(72) Inventors: Wenhao SUN, Singapore (SG); Huiling ZHOU, Singapore (SG); Jiandong ZHANG, Beijing (CN)

(21) Appl. No.: 19/038,108

(22) Filed: Jan. 27, 2025

(30) Foreign Application Priority Data
Mar. 1, 2024 (CN) 202410238544.5

(51) Int. Cl. G06T 19/20; G06T 5/70

(52) U.S. Cl. CPC G06T 19/20; G06T 5/70; G06T 2207/20081; G06T 2207/30196; G06T 2210/16; G06T 2219/2021

(57) ABSTRACT

A try-on image generation method includes: obtaining a first image of a target model and a second image of an item of clothing to be tried on; performing image processing on the first image to generate a plurality of third images, each expressing different information; performing clothing deformation processing on the item of clothing in the second image based on the first image to obtain a fourth image, wherein a clothing shape in the fourth image aligns with a pose of the target model; and generating a try-on image of the target model wearing the clothing in the corresponding pose based on the third images, the fourth image, the first image, and the second image.

### CROSS-REFERENCE TO RELATED APPLICATIONS

This application claims priority to Chinese Patent Application No. 202410238544.5, filed with the China National Intellectual Property Administration on Mar. 1, 2024, and entitled “Try-On Image Generation Method, System, and Model Training Method,” which is incorporated herein by reference in its entirety.

### TECHNICAL FIELD

The present application relates to the field of computer technology, particularly to a method for generating try-on images, a system for generating try-on images, a method for training a try-on image generation model, an electronic device, a storage medium, and a computer program product.

### BACKGROUND

Virtual Try-On (VTON) is a technology that visualizes the effect of wearing clothing on a model without the need for the model to physically try on the clothing. With the rapid development of Artificial Intelligence Generated Content (AIGC) in recent years, VTON has garnered increasing attention. For e-commerce platforms in particular, VTON can generate high-quality and diverse materials for campaigns, help merchants reduce the cost of physical photoshoots with models, shorten the time needed to produce try-on images, and provide users with a smoother online shopping experience. However, existing solutions for generating try-on images using virtual try-on technology have the following shortcomings: they fail to consistently preserve clothing details and cannot accurately restore the original physical characteristics of the model, such as body shape. For example, in some cases, the generated try-on images display significantly deformed clothing or lack realism.

It is evident that the existing methods for generating try-on images in the prior art still require improvement.

### SUMMARY

The embodiments of the present application provide a method for generating try-on images that can maintain the clothing details in the generated try-on images, reduce abnormal deformations of the clothing, and improve the overall quality of the generated try-on images.

Correspondingly, the embodiments of the present application also provide a method for training a try-on image generation model, a try-on image generation system, an electronic device, a storage medium, and a computer program product to ensure the implementation and application of the aforementioned method.

In particular, one embodiment of the present application discloses a method for generating a try-on image, which is applied to the server side. The method includes the following steps:
obtaining a first image of a target model and a second image of a clothing to be tried on;
performing image processing on the first image to generate a plurality of third images, each expressing different information;
performing clothing deformation processing on the clothing in the second image based on the first image to obtain a fourth image, wherein a clothing shape in the fourth image aligns with a pose of the target model;
generating a try-on image of the target model wearing the clothing to be tried on in the target model's pose based on the third images, the fourth image, the first image, and the second image.

The embodiments of the present application also disclose a method for training a try-on image generation model, the method including the following steps:
obtaining an image pair including a sample model image and a sample clothing image, wherein the clothing in the sample model image and the sample clothing image within the sample image pair is the same but differs in shape;
using the image pair as input images for the try-on image generation model to be trained, and controlling the try-on image generation model to generate a try-on image;
iteratively optimizing the try-on image generation model to be trained with an objective of aligning the generated try-on image with the sample model image, thereby obtaining a trained try-on image generation model;
wherein controlling the try-on image generation model to be trained to generate a try-on image includes:
performing image processing on the sample model image to obtain a plurality of model information images expressing different information;
performing clothing deformation process on the clothing in the sample clothing image based on the sample model image to obtain a clothing deformation image, wherein a clothing shape in the clothing deformation image aligns with a pose of the model in the sample model image; and
controlling the try-on image generation model to be trained to generate the try-on image based on the model information images, the clothing deformation image, the sample model image, and the sample clothing image.

The embodiments of the present application also disclose a method for generating a try-on image, applied to a client. The method includes the following steps:
obtaining a clothing image of a clothing to be tried on and a user image of a current user in a target pose uploaded by the user;
generating a try-on request based on the user image and the clothing image in response to a try-on image generation operation, and sending the try-on request to a preset server;
obtaining a try-on image generated by the preset server in response to the try-on request, wherein the try-on image depicts the user wearing the clothing to be tried on in the target pose;
displaying the try-on image to the current user, wherein the try-on image is generated by the preset server through the following process: performing image processing on the user image to generate a plurality of third images expressing different information; applying clothing deformation processing to the clothing in the clothing image based on the user image to obtain a fourth image, wherein a clothing shape in the fourth image matches the user's pose in the user image; generating the try-on image based on the third images, the fourth image, the user image, and the clothing image.

The embodiments of the present application also disclose a method for generating a try-on image, applied to a client. The method includes the following steps:
obtaining a first image of a target model in a target pose selected by a current user and a second image of a clothing to be tried on;
generating a try-on request based on the first image and the second image in response to a try-on image generation operation, and sending the try-on request to a preset server;
obtaining a try-on image generated by the preset server in response to the try-on request;
displaying the try-on image to the current user;
wherein the try-on image is generated by the preset server through the following method: performing image processing on the first image to generate a plurality of third images, each expressing different information; applying clothing deformation processing to the clothing in the second image based on the first image to obtain a fourth image, wherein a clothing shape in the fourth image matches the target pose of the target model in the first image; and generating the try-on image based on the third image, the fourth image, the first image, and the second image, wherein the try-on image depicts the target model wearing the clothing to be tried on in the target pose.

The embodiments of the present application also disclose a try-on image generation system, which includes a client and a server, wherein:
the client is configured to obtain a first image of a target model and a second image of a clothing to be tried on;
the client is further configured to generate a try-on request based on the first image and the second image in response to a try-on image generation request, and send the try-on request to the server;
the server is configured to perform image processing on the first image to generate a plurality of third images, each expressing different information, and to deform the clothing in the second image based on the first image to obtain a fourth image, wherein a clothing shape in the fourth image matches the target pose of the target model in the first image;
the server is further configured to generate a try-on image, based on the third images, the fourth image, the first image, and the second image, wherein the try-on image depicts the target model wearing the clothing to be tried on in the target pose, and send the try-on image to the client;
the client is further configured to receive the try-on image sent by the server and display the try-on image to a current user.

The embodiments of the present application also disclose an electronic device, which includes: a processor, and a memory in communication with the processor; the memory stores a computer-executable instruction; the processor executes the computer-executable instruction stored in the memory to implement the methods described in the embodiments of the present application.

The embodiments of the present application also disclose a computer-readable storage medium, wherein the computer-readable storage medium stores a computer-executable instruction, which, when executed by a processor, implement the methods described in the embodiments of the present application.

The embodiments of the present application also disclose a computer program product, including a computer program/computer-executable instructions, which, when executed by a processor in an electronic device, implement the methods described in the embodiments of the present application.

Compared with the prior art, the embodiments of the present application offer the following advantages:
by obtaining a first image of the target model and a second image of the clothing to be tried on, performing image processing on the first image to obtain a plurality of third images expressing different information, and applying a clothing deformation process to the clothing in the second image based on the first image to obtain a fourth image, wherein the clothing shape in the fourth image aligns with the pose of the target model, and then, based on the third image, the fourth image, the first image, and the second image, generating a plurality of control signals to guide the try-on image generation process, these control signals including information from the clothing deformation process and the original features of the clothing in the second image, the embodiments ensure that the generated try-on image effectively preserves the clothing details and better fits the body shape of the target model, thereby enhancing the realism of the try-on image.

### BRIEF DESCRIPTION OF THE DRAWINGS

FIG. 1 is a flowchart illustrating the steps of one embodiment of the try-on image generation method disclosed in the present application.

FIG. 2 is a schematic diagram of the first and second images in the try-on image generation method disclosed in this embodiment of the present application.

FIG. 3 is a schematic diagram of the third image generated based on the first image in the try-on image generation method disclosed in this embodiment of the present application.

FIG. 4 is a schematic diagram illustrating the principle of clothing deformation in the try-on image generation method disclosed in this embodiment of the present application.

FIG. 5 is a schematic diagram illustrating the principle of generating try-on images in the try-on image generation method disclosed in this embodiment of the present application.

FIG. 6 is a flow diagram illustrating an embodiment of the try-on image generation model training method disclosed in the present application.

FIG. 7 is a flow diagram illustrating another embodiment of the try-on image generation method disclosed in the present application.

FIG. 8 is a flow diagram illustrating yet another embodiment of the try-on image generation method disclosed in the present application.

FIG. 9 is a schematic diagram of an exemplary device provided in one embodiment of the present application.

### DETAIL DESCRIPTION OF THE EMBODIMENTS

To make the objectives, features, and advantages of the present application more apparent and understandable, the following detailed description is provided with reference to the accompanying drawings and specific embodiments.

The try-on image generation method disclosed in the embodiments of the present application can be applied to various scenarios such as virtual try-on applications, try-on image generation systems, and e-commerce platforms. Based on an image of a target model and an image of the clothing to be tried on, a try-on image can be generated, showing the target model wearing the clothing in the pose depicted in the image.

To preserve the clothing details in the generated try-on image and reduce abnormal deformations, the try-on image generation method disclosed in the embodiments of the present application can quickly generate high-fidelity try-on images while maintaining clothing details.

The following provides examples to illustrate specific embodiments of the try-on image generation method based on the try-on image generation model disclosed in the present application.

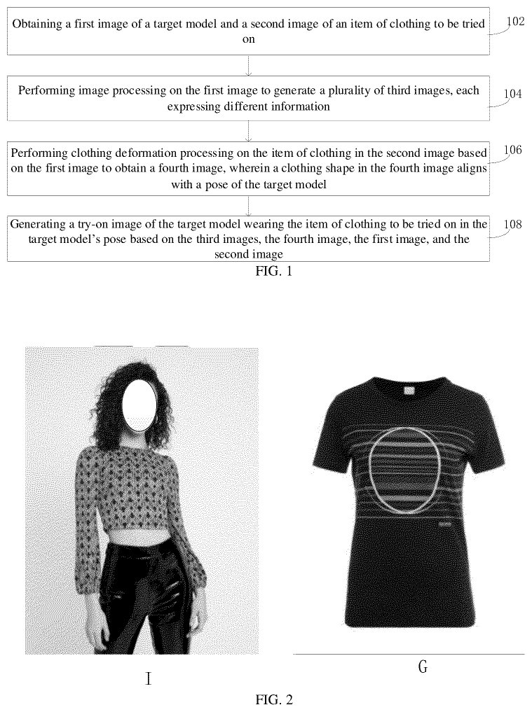

Referring to FIG. 1, in an optional embodiment, the present application discloses a method for generating try-on images, applied to a server, which includes steps 102 through 108.
S102: obtaining a first image of a target model and a second image of a clothing to be tried on.

In some optional embodiments, the first image can be a picture of the target model wearing clothing other than the clothing to be tried on. The target model can be a real-life model, a digital model, or a mannequin.

The second image is a frontal image of the clothing to be tried on. For example, the second image can be a flat image of the clothing or a front-facing image of the clothing taken after being worn by a mannequin. The clothing to be tried on includes, but is not limited to, any of the following: tops, pants, dresses, etc.

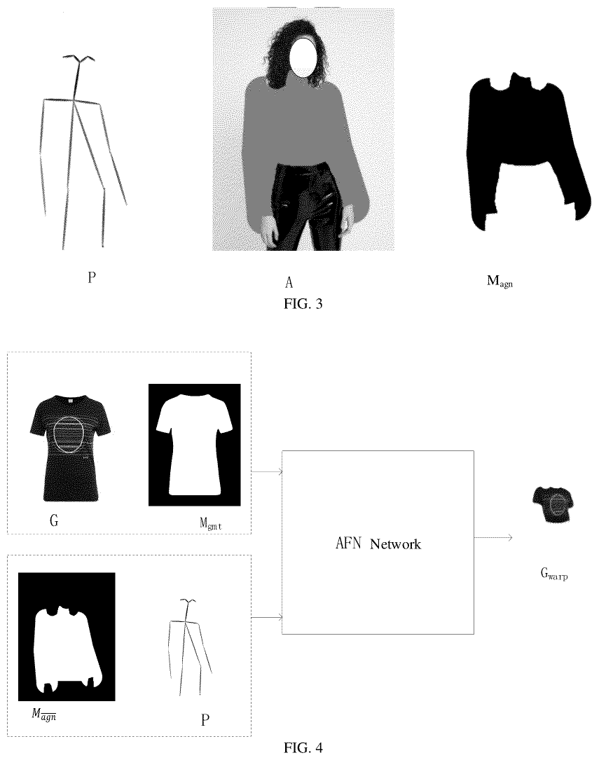

In a possible scenario, the first image of the target model can be the image I shown on the left side of FIG. 2, and the second image can be the image G shown on the right side of FIG. 2.

In some optional application scenarios, the first image and the second image can be images uploaded by the client. For example, when the try-on image generation method disclosed in the present application is applied to a try-on image generation application on the server side, the corresponding client is provided with an upload interface for the model image and the clothing image to be tried on, along with a button to request the generation of the try-on image. The user can upload the first image and the second image through the upload interface provided by the client, and trigger the request button. The client then generates a try-on request based on the first and second images uploaded by the user and sends the request to the preset server. The preset server, after parsing the try-on request, retrieves the first image of the target model and the second image of the clothing to be tried on.

In other optional application scenarios, the first image and the second image can be images that are downloaded from a preset database based on the image information included in the try-on request sent by the client. For example, when the try-on image generation method disclosed in the present application is applied to the server side of a try-on image generation platform, the corresponding client provides an interface for selecting model images and clothing images to be tried on, along with a button for generating the try-on image. The user can access the preset model database and preset clothing database via the selection interface set by the client, choose a model image as the first image, and choose a flat image of the clothing as the second image, then trigger the request button. The client then generates a try-on request based on the access addresses of the selected first and second images and sends the request to the preset server. The preset server, after parsing the try-on request, retrieves the access addresses for the first image of the target model and the second image of the clothing to be tried on, and then, based on these access addresses, downloads the first image and the second image from the preset model database and the preset clothing database, respectively.

The above examples only illustrate two specific embodiments for obtaining the first image and the second image in two different scenarios. In actual implementation, other methods can also be used to obtain the first image and the second image. The embodiments of the present application do not limit the specific methods for obtaining the first image of the target model and the second image of the clothing to be tried on.
S104: performing image processing on the first image to generate a plurality of third images, each expressing different information.

In the embodiments of the present application, the goal of generating the try-on image is to produce an image showing the target model from the first image wearing the clothing from the second image, while retaining the model's pose in the first image and the details of the clothing to be tried on. To achieve this objective, the embodiments of the present application extract various control information from the first image to be used as denoising control signals in the try-on image generation process. The control information includes, but is not limited to, the following: model pose, the body area of the model corresponding to the clothing to be tried on, and image information to be retained. Among these, the model pose is used to control the pose of the model in the generated try-on image; the body area of the model corresponding to the clothing to be tried on is used to control the region of the image covered by the clothing in the try-on image; and the retained image information is used to control the content of the image areas outside of the clothing to be tried on in the generated try-on image.

Each type of control information is expressed through a separate image. By performing image processing on the first image, a plurality of images are obtained, each expressing different control information. In the embodiments of the present application, the images obtained by processing the first image are referred to as “third images.”

In some optional embodiments, the image processing of the first image to obtain a plurality of third images expressing different information includes: extracting human skeletal pose information from the first image to obtain a third image that represents the skeletal pose of the target model in the first image; and/or, performing occlusion processing on the target image area of the first image to obtain a third image with the clothing expression removed; and/or, performing masking processing on the first image to obtain a third image that represents the redrawn area.

The following provides examples of how each third image obtained by processing the first image is generated, along with their respective image content.

### (1) Third Image Expressing Human Skeletal Pose

In some optional embodiments, a human skeletal pose model from the prior art can be used to generate a third image that represents the human skeletal pose of the target model in the first image. For example, the first image is input into an existing human skeletal pose model to obtain the human skeletal pose diagram output by the model, which is then used as one of the third images generated from the first image. Taking the first image shown in FIG. 2 as an example, the third image expressing the human skeletal pose obtained after image processing is shown as image P in FIG. 3.

The method of extracting human skeletal pose information from the first image to obtain a third image expressing the skeletal pose of the target model in the first image is a known technique in the prior art and will not be further elaborated in this embodiment of the present application.

(2) Third Image with Clothing Expression Removed

In some optional embodiments, the target image area includes the wearing area corresponding to the clothing to be tried on. The third image, with the clothing expression removed, satisfies the following conditions: the clothing image on the target model in the first image is hidden, while the identity features of the target model (such as the face, head, and hands) are kept, and the pose and body shape information of the target model are preserved.

For example, when the clothing to be tried on is an upper item of clothing, the target image area includes the upper body of the model in the first image (excluding the head, face, and hands); when the clothing to be tried on is a lower item of clothing, the target image area includes the lower body of the model in the first image; and when the clothing to be tried on is a dress, the target image area includes the torso and limbs (excluding the hands) of the model in the first image.

In some optional embodiments, the process of performing occlusion on the target image area in the first image to obtain a third image with the clothing expression removed includes setting the pixel values of the specified image area in the first image to preset pixel values, thereby obtaining the third image with the clothing expression removed. For example, when the clothing to be tried on is an upper item of clothing, the pixel values of the image area corresponding to the upper body of the target model (excluding the head and hands) in the first image are set to the corresponding gray pixel values. When the clothing to be tried on is a dress, the pixel values of the image area corresponding to the torso and limbs (excluding the hands) of the target model are set to the corresponding gray pixel values. Taking the first image shown in FIG. 2 as an example, the third image with the clothing expression removed after image processing is shown as image A in FIG. 3.

Optionally, the target image area can be determined using image segmentation techniques.

In other optional embodiments, other methods may also be used to perform occlusion on the target image area in the first image to obtain the third image with the clothing expression removed. The specific implementation of occluding the target image area in the first image to generate the third image with the clothing expression removed is not limited in this embodiment.

### (3) Third Image Expressing the Redrawing Area

In the embodiments of the present application, the redrawing area represents the image region in the generated try-on image that is outside of the content to be retained. For example, when the clothing to be tried on is an upper item of clothing, the redrawing area is the image area in the first image excluding the head, face, hands, and lower body of the target model. Similarly, when the clothing to be tried on is a lower item of clothing, the redrawing area is the image area in the first image excluding the head, face, hands, and upper body of the target model.

In some optional embodiments, the method can first perform clothing segmentation on the first image to obtain the image area covered by the clothing worn by the target model in the first image. Then, based on the clothing-covered image area, a masking process is applied to the first image to generate a clothing mask image, which serves as the third image expressing the redrawing area. For example, the pixel values of the image area covered by the clothing in the first image can be set to black pixel values, while the pixel values of the other areas are set to white pixel values, thereby obtaining a clothing mask image. Taking the first image shown in FIG. 2 as an example, the third image expressing the redrawing area obtained after image processing is shown as image M_{agn} in FIG. 3.

In other optional embodiments, other methods may also be used to apply masking to the first image to obtain the third image expressing the redrawing area. The embodiments of the present application do not limit the specific methods for performing the masking process on the first image to generate the third image expressing the redrawing area.
S106: performing clothing deformation processing on the item of clothing in the second image based on the first image to obtain a fourth image, wherein a clothing shape in the fourth image aligns with a pose of the target model.

In the embodiments of the present application, the control signals for generating the try-on image not only include the control information carried by the aforementioned third images (the ones expressing the target model's skeletal pose, the ones removing the clothing expression, and the ones expressing the redrawing area), but also include the control information carried by the item of clothing to be tried on. The control information carried by the item of clothing to be tried on fully expresses the appearance features of the item of clothing.

In order to make the item of clothing to be tried on fit the body shape of the target model, the item of clothing is first subjected to a deformation process to align its shape with the pose of the target model.

The Appearance Flow Network (AFN) is a technique similar to those commonly used for predicting optical flow between two or more images. In the context of virtual try-on technology, AFN is often used for clothing deformation (warping) to achieve spatial alignment between the clothing and the target model. The Appearance Flow Network consists of: Dual-Tower Structure: each branch of the dual-tower structure is a pyramid network used to extract multi-level features from both clothing-related inputs and model-related inputs. Alignment Network: the alignment network processes the features extracted by the dual-tower structure and ultimately outputs the deformed clothing image that aligns with the model's pose.

The following describes an embodiment of the technical solution for clothing deformation processing to obtain a fourth image, with reference to FIG. 4.

In some optional embodiments, the method of performing clothing deformation processing on the item of clothing in the second image based on the first image to obtain a fourth image includes the following steps: obtaining a fifth image that represents the skeletal pose of the target model in the first image; obtaining a sixth image that represents the body shape and pose of the model in the first image; obtaining a seventh image by applying a masking process to the item of clothing in the second image; using the fifth and sixth images as the first branch input to a pre-trained appearance flow deformation network, and using the second and seventh images as the second branch input to the appearance flow deformation network. The item of clothing in the second image is then deformed by the network, and the resulting deformed item of clothing is output as the fourth image.

The specific method for obtaining the fifth image, which represents the skeletal pose of the target model in the first image, refers to the method described earlier for obtaining the third image that expresses the skeletal pose. This will not be repeated here. The fifth image (i.e., the skeletal pose image, such as image P in FIG. 3) contains sparse pose information of the model. In order to obtain more target position information for deforming the item of clothing, the embodiment of this application further processes the first image to obtain the sixth image, which represents the body shape and pose of the model in the first image.

In some optional embodiments, the method described earlier can be used to obtain the third image that expresses the redrawing region from the first image. Then, the background area in the third image can be subjected to an inverse color processing to obtain the sixth image. Taking the first image shown in FIG. 2 as an example, the resulting sixth image is shown in image M_{a̅g̅n̅} in FIG. 4.

The specific implementation for obtaining the seventh image, which is the result of performing clothing mask processing on the second image G, can be found in the prior art. This detailed implementation is not repeated in this embodiment. The seventh image obtained by performing clothing mask processing on the second image shown in FIG. 2 is shown as image M_{a̅g̅n̅} in FIG. 4.

As can be seen from the generation methods of the fifth and sixth images, the model pose information in the fifth image is sparse, while the sixth image contains more target location information, but does not include precise positioning details such as those for the arms. By combining the fifth and sixth images as inputs for one branch of the dual-tower structure in the Appearance Flow Network (i.e., the model-related input), the accuracy of the target positions for clothing deformation can be improved. On the other hand, the seventh image, which is obtained by applying a clothing mask to the second image, filters out image information unrelated to the clothing. By combining the seventh image and the second image as inputs for the other branch of the dual-tower structure in the Appearance Flow Network (i.e., the clothing-related input), the network can effectively preserve the shape, color, and design details of the clothing in the second image, while filtering out background interference. This results in improved completeness and accuracy of the clothing details in the fourth image output by the Appearance Flow Network.

Optionally, the Appearance Flow Network can be pre-trained based on a previously obtained dataset. The dataset can be one that has been publicly disclosed in the existing art for high-resolution virtual try-on clothing. The dataset needs to include several images of models in frontal poses and corresponding clothing images. The training method for the Appearance Flow Network is described in existing technology, and will not be further elaborated in this embodiment.

After the target model's pose and body shape in the first image shown in FIG. 2 are aligned with the try-on clothing in FIG. 2, the deformed clothing image (i.e., the fourth image) obtained is shown in image G_{warp} in FIG. 4.
S108: generating a try-on image of the target model wearing the item of clothing to be tried on in the target model's pose based on the third images, the fourth image, the first image, and the second image.

Diffusion models are a type of Markov chain trained using variational estimation. The goal is to model the diffusion process of data points in the latent space to learn the hidden space structure of a dataset. In the field of computer vision, related research trains neural networks to learn the reverse diffusion process, allowing them to gradually denoise images that have been corrupted with Gaussian noise. These models have been widely applied in image and video generation tasks. Latent Diffusion Models (LDMs) are a variant of diffusion models. LDMs perform the diffusion process in the latent space of a Variational Auto-Encoder (VAE), enabling more efficient training and prediction.

In the embodiment of the present application, a try-on image generation model is constructed based on the LDMs (Latent Diffusion Models) framework. The try-on image generation model includes: a visual feature extraction network, a noise addition module, and a generation network. The noise addition module is used to add noise to the input model image, thereby obtaining a noisy image with Gaussian noise, which serves as the input image for the generation network. The generation network is used to perform denoising and restoration on the noisy image to generate the try-on image. The generation network adopts the LDMs framework, and during the denoising process, a plurality of control signals are introduced to control the generation of the try-on image. This allows for the rapid generation of high-fidelity try-on images while preserving the clothing details.

In some optional embodiments, the generation of the try-on image, where the target model is shown wearing the target clothing in the specified pose, based on the third image, the fourth image, the first image, and the second image, includes: using the first image and the second image as input images for a pre-trained try-on image generation model. The model generates denoising control signals during the denoising process based on the second image, the third image, and the fourth image. The try-on image generation model is then used to generate the try-on image of the target model wearing the target clothing in the specified pose. For example, the first image is first subjected to noise addition to obtain a noisy image with Gaussian noise. This noisy image is then input to the generation network for denoising and restoration.

The generation network first compresses the noisy image, converting the noisy image into a latent space vector. Then, through the denoising network in the generation network, denoising processing is performed on the latent space vector, with the process terminating when a preset iteration stopping condition is met. Finally, based on the latent space vector obtained from the last round of denoising, the try-on image is generated. During the denoising process, the a plurality of third images obtained from the previous steps, the fourth image, and the clothing features carried by the second image (the target clothing to be tried on) are used as control signals for the denoising network, influencing the denoising process to generate the desired try-on image.

Below with reference to the schematic diagram of the working principle of the try-on image generation model shown in FIG. 5, an example is provided to illustrate the try-on image generation method.

In some optional embodiments, the first image and the second image are used as input images for a pre-trained try-on image generation model. Based on the second image, the third image, and the fourth image, denoising control signals are generated during the denoising process of the try-on image generation model. The try-on image of the target model wearing the target clothing in the specified pose is generated through the try-on image generation model, including the following sub-steps S1 to S4:
Sub S1: extracting visual features from the second image to obtain a feature vector representing the clothing to be tried on.

In some optional embodiments, a pre-trained visual feature extraction network may be used to extract features from the second image, thereby obtaining a feature vector of the second image. Optionally, the visual feature extraction network may include: a Vision Transformer (ViT) and a Multi-Layer Perceptron (MLP). The process of extracting visual features from the second image to obtain the feature vector of the clothing to be tried on includes: encoding the second image through the Vision Transformer to obtain an encoding vector; and performing feature processing on the encoding vector through the Multi-Layer Perceptron to obtain the feature vector of the clothing to be tried on. For example, the Vision Transformer may encode the input clothing image and extract high-level semantic information (such as the shape of the collar, sleeve length, etc.) from the image to produce a multi-level encoding vector. Then, the Multi-Layer Perceptron processes the encoding vectors from the a plurality of hidden layers of the Vision Transformer to generate a higher-level representation, which is used as the feature vector of the input clothing image.
Sub S2: applying noise to the first image using the denoising module of the pre-trained try-on image generation model to obtain a noisy image.

The specific method for adding noise to the first image to obtain the noisy image can be referred to in existing technology and is not repeated here.
Sub S3: performing multi-step denoising on the noisy image through the generation network of the try-on image generation model to obtain latent space vectors at each time step. The multi-step denoising process includes: concatenating the third image and the fourth image with the latent space vector output from the previous time step along the image channel dimension to obtain a concatenated vector. Then, using an attention mechanism, perform feature interaction between the concatenated vector and the feature vector to obtain the latent space vector output at the current time step.

Optionally, the generation network can be a denoising network based on an attention mechanism.

In the existing LDMs framework, the denoising network based on the attention mechanism (i.e., the UNet network) has two parts as its input: the latent space vector output from the previous time step, which is input to the convolutional layer, and the local conditions, such as query text or images, input to the attention module. In the embodiment of the present application, the generation network of the try-on image generation model built based on the LDMs framework concatenates the third image and the fourth image with the latent space vector output from the previous time step along the image channel dimension to obtain a concatenated vector. Then, the concatenated vector replaces the latent space vector output from the previous time step as the input to the convolutional layer of the denoising network. At the same time, the feature vector of the second image is used as the local condition to replace the query text or image, controlling the denoising process of the concatenated vector.

The denoising network gradually removes the Gaussian noise from the noisy image to obtain a clearer and more realistic image. In the embodiment of the present application, a plurality of control signals are introduced during each step of the denoising process. For example, let the first image be represented as I, the third image representing human skeletal pose as P, the third image representing the removal of clothing as A, the third image representing the re-drawing region as M_{agn}, the second image as G, and the fourth image as G_{warp}. Suppose the latent space vector output by the generation network at the t-th time step is represented as Î(t). At the t−1-th denoising time step, the third images P, A, M_{agn}, and the fourth image G_{warp} are concatenated with the latent space vector Î(t) output by the t-th denoising step along the image channel dimension to obtain the concatenated vector Î_{con}(t−1). This concatenated vector Îcon (t−1) is then input into the convolutional layer of the denoising network, and the output of the convolutional layer serves as the query input (i.e., Q value) for the attention mechanism. On the other hand, the feature vector G_{f}, obtained by performing feature extraction on the second image G through a pre-trained visual feature extraction network, is used as the local condition for the attention mechanism in the denoising network. This feature vector G_{f} is treated as the key-value pair input (i.e., K and V) for the attention mechanism, guiding the denoising process. Under the control of the third images P, A, M_{agn}, the fourth image G_{warp}, and the feature vector G_{f} of the second image G, the denoising network gradually completes the denoising process of the noisy image, continuing until the denoising process of the 0-th time step is finished.

Sub S4: generating the try-on image of the target model wearing the clothing in the specified pose based on the latent space vector output at the specified time step.

Optionally, the try-on image of the target model in the specified pose can be generated based on the latent space vector output at the last time step. For example, using the first and second images inputted in FIG. 2, the generated try-on image is shown in FIG. 5 as image I′.

As can be seen from the denoising process described above, after the target try-on clothing is feature-extracted using the Vision Transformer and Multi-Layer Perceptron, the resulting feature vector contains more high-level semantic information. The detailed features of the clothing, such as collar shape, sleeve length, etc., are accurately represented. On the other hand, the fourth image obtained after spatial alignment contains more low-level clothing details, which may contain errors after deformation processing through the appearance flow network in terms of high-level semantic features. In the generation network, both the feature vector of the second image and the fourth image are used together as denoising control signals. Through the attention mechanism, they interact within the denoising network to achieve a balance and complementarity between the high-level semantic information of the target try-on clothing from the second image and the low-level clothing details from the fourth image. This enhances the quality of the generated try-on image.

In summary, the try-on image generation method disclosed in the embodiments of the present application involves obtaining the first image of the target model and the second image of the clothing to be tried on; processing the first image to obtain a plurality of third images expressing different information. On the other hand, based on the first image, the clothing in the second image is subjected to clothing deformation processing to obtain a fourth image, where the clothing's shape in the fourth image is aligned with the target model's pose. Then, based on the third image, the fourth image, the first image, and the second image, a plurality of control signals are generated to guide the try-on image generation process. Among these control signals, there are those representing the information after clothing deformation processing and the original features of the clothing in the second image, ensuring that the generated try-on image effectively retains the clothing's detailed features. Furthermore, the generated try-on image is more closely aligned with the target model's body shape, enhancing the realism of the try-on image.

Testing has shown that when the control signals do not include the fourth image obtained from the clothing deformation process, there is a significant pose mismatch between the clothing to be tried on and the target model, thereby obtaining the generated try-on image often losing many detailed patterns of the clothing. However, when the control signals include the fourth image obtained from the clothing deformation process, by combining the fourth image with other control signals to guide the denoising process, even when there is a significant difference between the model's pose and the clothing's shape, the fourth image may lose certain clothing attributes (such as sleeve length, collar shape, etc.). Nevertheless, by combining the feature vector of the second image as a control signal, this situation can be tolerated, thereby improving the quality of the generated try-on image.

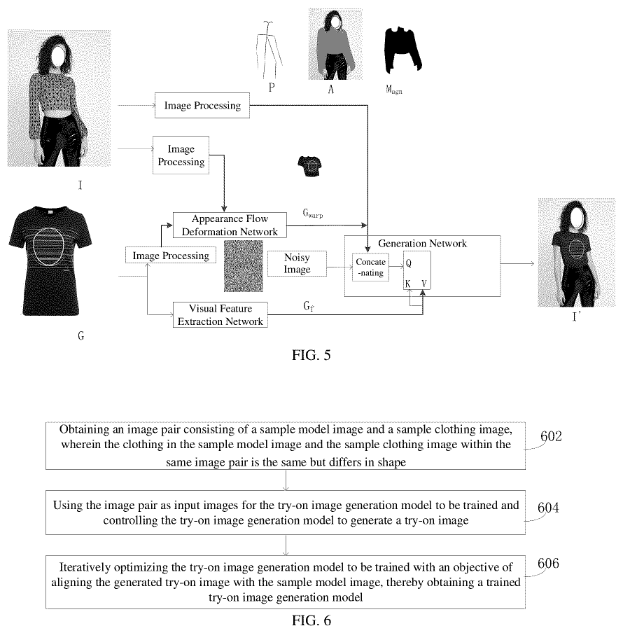

In order to implement the above-mentioned try-on image generation method, an additional try-on image generation model training method is disclosed in the present embodiment. The structure of the try-on image generation model is as previously described. As shown in FIG. 6, the method includes S602 to S606.
S602: obtaining an image pair including a sample model image and a sample clothing image, wherein the clothing in the sample model image and the sample clothing image within the same image pair is the same but differs in shape.

Optionally, an image pair from the publicly available dataset for virtual clothing try-on, as previously described, can be used to train the try-on image generation model. The dataset includes several model front images and clothing images. The clothing images in the dataset are typically flat lay images. However, in practical applications, the clothing images used for generating try-on images (such as the second image described earlier) may be images of clothing already worn by a model. To accommodate the diverse forms of clothing images for virtual try-on, it is necessary to collect a variety of clothing images to fit the complex and varied virtual try-on scenarios. However, collecting images of clothing worn by models in different poses is challenging and costly.

In some embodiments of the present application, a knowledge transfer strategy is employed to obtain diversified clothing images. Optionally, the method for obtaining image pairs composed of sample model images and sample clothing images includes: obtaining a first image pair composed of a sample model image and a sample clothing image, where the sample clothing image is a flat-laid image; performing clothing deformation processing on the sample clothing image in the same first image pair based on the sample model image to obtain the clothing deformation image corresponding to the sample model image; using the clothing deformation image as the sample clothing image and constructing a second image pair with the corresponding sample model image; integrating the first and second image pairs to obtain image pairs composed of sample model images and sample clothing images.

Firstly, obtaining image pairs from publicly available datasets for virtual clothing try-on in the prior art as the first image pair, and train the appearance flow deformation network based on the first image pair, enabling it to transform flat-laid clothing into clothing with the target pose. Then, use the appearance flow deformation network to transform the flat-laid clothing (such as the sample clothing image in the first image pair x1x_1x1) into a deformed clothing image that matches another model's pose. A new image pair is then generated based on the transformed clothing image and the corresponding sample model image (such as the sample model image in the first image pair x1x_1x1). This new image pair is used as the second image pair. The generated second image pair is then combined with the first image pair from the public dataset as training data.

By adding the image pairs constructed from the deformed clothing images, the training data now contains a mixture of real and synthetic data. Afterward, the appearance flow deformation network is trained on this combined dataset, enabling it to handle both flat-laid clothing images and clothing worn by a model. Training the try-on image generation model based on this expanded dataset can improve the model's adaptability to various scenarios, such as generating try-on images for clothing worn by a model. This approach enhances the quality of try-on images in complex scenarios and improves the model's robustness under data fluctuations.

The method for obtaining training data disclosed in the embodiments of this application does not require additional data collection or annotation, making it cost-effective and efficient.
S604: using the image pair as input images for the try-on image generation model to be trained and controlling the try-on image generation model to generate a try-on image.

Next, based on the expanded training data, the try-on image generation model is trained. During the training process of the model, the sample model image from the image pair is used as the target image for generating the try-on image. The process is as follows: first, noise is applied to the sample model image to obtain a noisy image; then, the noisy image is progressively denoised to generate the try-on image. The training objective of the try-on image generation model is to restore the sample model image.

The control of the try-on image generation model during training includes: processing the sample model image to obtain a plurality of model information images that represent different types of information; performing clothing deformation processing on the sample clothing image based on the sample model image to obtain a clothing deformation image, where the clothing's shape in the clothing deformation image is aligned with the pose of the model in the sample model image; and based on the model information images, the clothing deformation image, the sample model image, and the sample clothing image, controlling the try-on image generation model to generate the try-on image.

Optionally, processing the sample model image to obtain a plurality of model information images expressing different types of information includes: extracting human skeletal pose information from the sample model image to obtain a model information image representing the skeletal pose of the target model in the sample model image; and/or, covering the target image region in the sample model image to obtain a model information image with the clothing expression removed; and/or, performing masking processing on the sample model image to obtain a model information image representing the redrawn region. The target image region refers to the wearing area of the clothing in the sample clothing image that matches the sample model image.

The specific implementation method for processing the sample model image to obtain a plurality of model information images expressing different types of information can refer to the previous description of processing the first image to obtain a plurality of third images expressing different types of information. The details are not repeated here.

Optionally, the process of performing clothing deformation on the sample clothing image based on the sample model image to obtain a deformed clothing image includes: obtaining a fifth image that represents the skeletal pose of the model in the sample model image, and obtaining a sixth image that represents the body shape and pose of the model in the sample model image; obtaining a seventh image resulting from a clothing mask process applied to the sample clothing image; inputting the fifth image and the sixth image as the first branch input to a pre-trained appearance flow deformation network, and inputting the second image and the seventh image as the second branch input to the appearance flow deformation network. The network then performs clothing deformation processing on the sample clothing image, thereby obtaining the fourth image.

The specific implementation of performing clothing deformation on the sample clothing image based on the sample model image to obtain a deformed clothing image is similar to the implementation described for performing clothing deformation on the target clothing in the second image based on the first image, thereby obtaining the fourth image. This implementation has been described previously and will not be repeated here.

Optionally, controlling the training of the try-on image generation model based on the model information images, the clothing deformation image, the sample model image, and the sample clothing image includes: using the sample model image and the sample clothing image as the input images for the training model, and generating denoising control signals during the denoising process of the training try-on image generation model based on the sample clothing image, model information image, and the clothing deformation image. The try-on image is then generated by the training model.

In some optional embodiments, the sample model image and the sample clothing image are used as input images for a try-on image generation model to be trained. A denoising control signal is generated during the denoising process based on the sample clothing image, the model information image, and the clothing deformation image. The try-on image is then generated through the try-on image generation model to be trained. This process includes: performing visual feature extraction on the sample clothing image to obtain feature vectors of the clothing in the sample clothing image; applying a noise addition process to the sample model image using the noise addition module of the try-on image generation model to be trained, thereby obtaining a noisy image; using the generation network of the try-on image generation model to be trained, performing multi-time-step denoising on the noisy image to obtain latent space vectors output at each time step. The multi-time-step denoising process includes: concatenating the model information image and the clothing deformation image with the latent space vector output from the previous time step along the image channel dimension to form a concatenated vector; performing feature interaction between the concatenated vector and the feature vector based on an attention mechanism to obtain the latent space vector output for the current time step.

Using the sample model image and the sample clothing image as input images for the try-on image generation model to be trained, a denoising control signal is generated during the denoising process based on the sample clothing image, the model information image, and the clothing deformation image. The try-on image is then generated through the try-on image generation model to be trained. For the detailed implementation of generating the try-on image through the try-on image generation model to be trained, please refer to the previously described implementation of generating a try-on image based on the first image and the second image using the try-on image generation model. The details will not be repeated here.
S606: iteratively optimizing the try-on image generation model to be trained with an objective of aligning the generated try-on image with the sample model image, thereby obtaining a trained try-on image generation model.

After generating a try-on image for each pair of image data in the training dataset, a single iteration of training is completed. Subsequently, the difference between the generated try-on image and the sample model image in each image pair is evaluated to compute the generation loss for the try-on image generation model to be trained. Based on the generation loss, a determination is made as to whether the conditions for terminating the training process are met. If the conditions are met, the try-on image generation model to be trained, as obtained after the final iteration of training, is used as the completed try-on image generation model. If the conditions are not met, some or all of the model parameters of the try-on image generation model to be trained are optimized. Subsequently, the next training iteration is performed using the optimized model parameters.

In some optional embodiments, if the generation loss converges to meet a preset loss threshold, indicating that the generated try-on image is consistent or nearly consistent with the sample model image in the corresponding image pair, it can be considered that the try-on image generation model to be trained has completed training.

In some optional embodiments, as described previously, the try-on image generation model includes a visual feature extraction network composed of a vision transformer and a multi-layer perceptron, a noise addition module, and a generation network. To align the try-on image with the sample model image, iterative optimization of the try-on image generation model to be trained is performed. This includes iteratively optimizing the network parameters of the multi-layer perceptron and the generation network to achieve consistency between the try-on image and the sample model image. During the training process to obtain the try-on image generation model, the network parameters of the vision transformer are frozen, and only the network parameters of the stacked multi-layer perceptron are updated. This approach not only reduces the number of parameters to be trained, aiding model convergence, but also maintains efficiency. On the other hand, the visual feature extraction network, composed of the vision transformer and the multi-layer perceptron, enhances the expressiveness of the feature vectors extracted from the input images. This contributes to preserving the detailed information in the generated try-on images, improving their quality and fidelity.

In summary, the try-on image generation model training method disclosed in this application extends the training dataset and improves the model's robustness to data variations by obtaining image pairs including sample model images and sample clothing images, where the clothing in the sample model image and sample clothing image within the same pair is the same but differs in shape. During the process of using these image pairs as input images for the try-on image generation model to be trained, the generation of try-on images is controlled as follows: by processing the sample model image, a plurality of model information images expressing different information are obtained. Based on the sample model image, clothing deformation processing is applied to the clothing in the sample clothing image to obtain clothing deformation images, where the clothing shape in the deformation images aligns with the pose of the model in the sample model image. Using the model information images, clothing deformation images, sample model images, and sample clothing images as input, the generation of try-on images by the try-on image generation model is controlled. This approach ensures that the try-on images generated under a plurality of control signals retain detailed clothing features, achieve a higher degree of alignment with the model's pose and body shape, and exhibit enhanced realism.

By conducting comparative tests between the try-on image generation model trained using the training method disclosed in this application and existing open-source try-on image generation models based on an open-source dataset, the try-on image generation model trained with this method demonstrates superior performance. Specifically, it better preserves the original texture, patterns, and other features of the clothing while achieving harmonious integration with the model image. Further comparative tests were conducted using a test dataset composed of clothing worn on models. These tests compared the try-on image generation model trained with the disclosed method and existing open-source try-on image generation models. The results show that the try-on image generation model trained using the method disclosed in this application adapts more effectively to complex poses and occlusions in clothing images, generating try-on images with high fidelity and consistency.

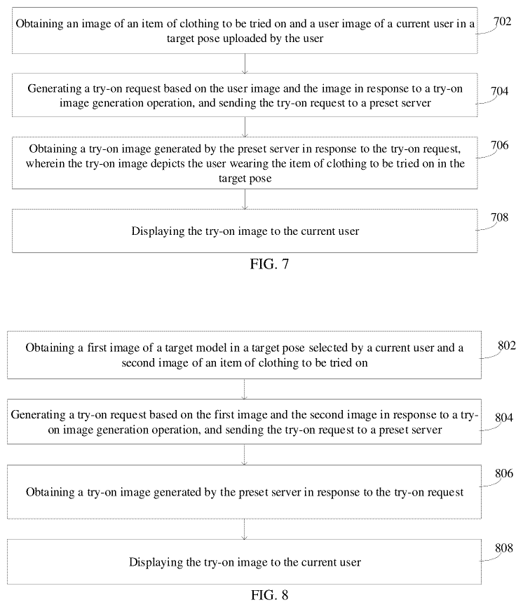

Based on the aforementioned embodiments, this application further discloses a try-on image generation method, applicable to a client device. As shown in FIG. 7, the method includes S702 through S708.
S702: obtaining an image of an item of clothing to be tried on and a user image of a current user in the target pose uploaded by the user.

The image for the item of clothing to be tried on can be an image of the item of clothing selected by the user through the try-on application on the client device. The user image can be an image uploaded via the client device, representing the current user or another user, and includes body pose information. For example, in one optional application scenario, the user image is the current user's image captured in real time by invoking an image acquisition device through the client application. In other optional application scenarios, the user image is an image uploaded by the user through a model image upload interface in the client settings.
S704: generating a try-on request based on the user image and the image of the item of clothing in response to a try-on image generation operation, and send the request to a preset server.

For example, the try-on request may include the user image and the image of the item of clothing directly, or it may include the download URLs for the user image and the clothing image.

The client sends the try-on request to a preset server. Upon receiving the try-on request from the client, the preset server parses the request and retrieves the user image and the image of the item of clothing based on the parsing results. Subsequently, the server generates a try-on image using the user image and the clothing image.

The try-on image is generated by the preset server using the following method: performing image processing on the user image to obtain a plurality of third images, each expressing different information; based on the user image, apply clothing deformation processing to the clothing in the image of the item of clothing to obtain a fourth image. In the fourth image, the clothing shape of the item of clothing to be tried on matches the pose of the user in the user image; using the third images, the fourth image, the user image, and the clothing image to generate the try-on image.

The specific implementation of the server's try-on image generation process can be referred to in the relevant descriptions in the previous embodiments and will not be repeated here.

Subsequently, the server sends the generated try-on image as the response data to the client in reply to the try-on request.
S706: obtaining a try-on image generated by the preset server in response to the try-on request, wherein the try-on image depicts the user wearing the item of clothing to be tried on in the target pose.
S708: displaying the try-on image to the current user.

The client receives the try-on image sent by the server and displays it to the user.

In summary, the try-on image generation method disclosed in this application can generate try-on images in real-time based on the user image provided by the user and the clothing image selected by the user. The try-on image preserves the detailed features of the clothing in the clothing image, while ensuring the clothing in the try-on image fits the user's body shape and pose more closely. This enhances the realism of the try-on image and significantly improves the user experience.

Based on the above embodiments, this application further discloses a try-on image generation method applicable to a client device. As shown in FIG. 8, the method includes S802 through S808.
S802: obtaining a first image of a target model in a target pose selected by a current user and a second image of an item of clothing to be tried on.

The second image can be the image of the item of clothing to be tried on, either selected by the user through the try-on application or system client, or uploaded by the user. The first image can be a model image chosen by the user through the client application. Optionally, the first image represents a dressed image of the target model in the target pose. The target model may include, but is not limited to, any of the following: digital model; real-life model; mannequin model.

For example, in an optional application scenario, the first image may be a pre-configured model image in the clothing try-on system, selected by a merchant user through the client application. The second image may be an image of the item of clothing to be tried on, uploaded by the merchant user.
S804: generate a try-on request based on the first image and the second image in response to a try-on image generation operation, and sending the try-on request to a preset server.

For example, the try-on request may directly include the first image and the second image, or it may include the download URLs for the first image and the second image.

The client sends the try-on request to the preset server. Upon receiving the request, the server parses it to retrieve the first image and the second image based on the parsed results. Subsequently, the server generates a try-on image using the first image and the second image.

The try-on image is generated by the preset server using the following method: performing image processing on the first image to obtain a plurality of third images, each expressing different information; applying clothing deformation processing to the item of clothing in the second image based on the first image, thereby obtaining a fourth image, in the fourth image, the clothing shape of the item of clothing to be tried on matches the target pose of the target model in the first image; using the third images, the fourth image, the first image, and the second image to generate a try-on image, which depicts the target model in the target pose wearing the item of clothing to be tried on.

The specific implementation of generating the try-on image based on the first image and the second image can be referred to in the previous embodiments and will not be repeated here.
S806: obtaining a try-on image generated by the preset server in response to the try-on request.
S808: displaying the try-on image to the current user.

The client receives the try-on image sent by the server and displays it to the user.

In summary, the try-on image generation method disclosed in this application can generate try-on images in real-time based on the first image selected by the user and the second image uploaded by the user. The try-on image preserves the detailed features of the clothing in the second image and ensures that the clothing aligns closely with the body shape and pose of the model in the first image. This enhances the realism of the try-on image and effectively improves its quality, providing a better user experience.

Based on the above embodiments, this application further discloses a try-on image generation system for implementing the above-mentioned try-on image generation method.

The try-on image generation system includes: a client and a server, wherein:

the client is configured to obtain the first image of the target model and the second image of the item of clothing to be tried on;

the client is further configured to, in response to a try-on image generation operation, generate a try-on request based on the first image and the second image, and send the try-on request to the server;

the server is configured to perform image processing on the first image to obtain a plurality of third images expressing different information, and it also applies clothing deformation processing to the item of clothing in the second image based on the first image to obtain a fourth image, where the clothing shape in the fourth image matches the target pose of the target model in the first image;
the server is further configured to generate a try-on image based on the third images, the fourth image, the first image, and the second image, where the target model in the target pose is shown wearing the item of clothing to be tried on, and the server then sends the try-on image to the client;
the client is further configured to receive the try-on image sent by the server and display it to the current user.

The specific implementation of how the client obtains the first image of the target model and the second image of the item of clothing to be tried on can be referred to in the detailed implementations described in previous embodiments. These include the methods for obtaining the first and second images, as well as the methods for obtaining user images and clothing images. These details will not be repeated here.

The specific implementation of how the server generates the try-on image can be referred to in the relevant descriptions in previous embodiments and will not be repeated here.

In summary, the try-on image generation system disclosed in this application obtains the first image of the target model and the second image of the item of clothing to be tried on through the client. Subsequently, the server generates the try-on image based on the first and second images. During the generation process, the server processes the first image to obtain a plurality of third images expressing different information. It also performs clothing deformation processing on the item of clothing in the second image based on the first image to generate a fourth image, ensuring that the clothing shape in the fourth image matches the target pose of the target model in the first image. Finally, the server generates the try-on image by combining the third images, the fourth image, the first image, and the second image. The try-on image generated by the server retains the detailed features of the item of clothing from the second image and ensures that the clothing aligns closely with the body shape and pose of the target model in the first image. This significantly enhances the quality of the try-on image.

It should be noted that, for the method embodiments, the descriptions are presented as a series of action combinations for simplicity. However, those skilled in the art should understand that the embodiments of this application are not limited by the described action sequence, as certain steps may be performed in a different order or simultaneously, depending on the implementation of this application. Furthermore, those skilled in the art should also recognize that the embodiments described in the specification are preferred embodiments, and the actions involved are not necessarily mandatory for all implementations of this application.

Based on the above embodiments, this embodiment further provides a try-on image generation device, which includes the following modules:
first image and second image acquisition module: this module is configured to obtain the first image of the target model and the second image of the item of clothing to be tried on;
third image acquisition module: this module processes the first image to obtain a plurality of third images, each expressing different information;
clothing deformation module: this module performs clothing deformation processing on the item of clothing in the second image based on the first image to generate a fourth image. In the fourth image, the clothing shape of the item of clothing to be tried on is aligned with the pose of the target model;
try-on image generation module: this module generates a try-on image based on the third images, the fourth image, the first image, and the second image, and the try-on image depicts the target model in the specified pose wearing the item of clothing to be tried on.

Optionally, the third image acquisition module is further configured to perform:
extracting human skeletal pose information from the first image to obtain a third image representing the skeletal pose of the target model in the first image; and/or
performing occlusion processing on the target image region within the first image to obtain a third image that removes the expression of the clothing; and/or
performing mask processing on the first image to obtain a third image representing the redrawn region.

Optionally, the target image region includes the wearing region that matches the item of clothing to be tried on.

Optionally, the clothing deformation module is further configured to perform:
obtaining a fifth image representing the skeletal pose of the target model in the first image, and a sixth image representing the body shape and pose of the model in the first image;
obtaining a seventh image by performing mask processing on the second image to isolate the item of clothing to be tried on;
using the fifth image and the sixth image as the first branch input of a pre-trained appearance flow deformation network, and the second image and the seventh image as the second branch input of the appearance flow deformation network, and performing clothing deformation processing on the item of clothing to be tried on using the appearance flow deformation network to obtain the fourth image.

Optionally, the try-on image generation module is further configured to perform:
using the first image and the second image as input images for a pre-trained try-on image generation model to generate a denoising control signal during the denoising process of the try-on image generation model based on the second image, the third image, and the fourth image, and using the try-on image generation model to generate a try-on image of the target model wearing the item of clothing to be tried on in the specified pose.

Optionally, the process of using the first image and the second image as input images for a pre-trained try-on image generation model, generating a denoising control signal based on the second image, the third image, and the fourth image during the denoising process, and generating a try-on image of the target model in the specified pose wearing the item of clothing to be tried on through the try-on image generation model includes:
performing visual feature extraction on the second image to obtain the feature vector of the item of clothing to be tried on;
using the noise addition module of the pre-trained try-on image generation model to add noise to the first image, thereby obtaining a noisy image;
using the generation network of the try-on image generation model to perform multi-time-step denoising on the noisy image, obtaining latent space vectors at each time step, wherein the multi-time-step denoising process includes: concatenating the third image, the fourth image, and the latent space vector output from the previous time step along the image channel dimension to form a concatenated vector; performing feature interaction between the concatenated vector and the feature vector based on an attention mechanism to obtain the latent space vector output for the current time step;
generating the try-on image of the target model wearing the item of clothing in the specified pose based on the latent space vector output at the specified time step.

In summary, the try-on image generation device disclosed in the embodiments of this application achieves the following: obtains the first image of the target model and the second image of the item of clothing to be tried on; processing the first image to obtain a plurality of third images, each expressing different information; applying clothing deformation processing to the item of clothing in the second image based on the first image to generate a fourth image, the clothing shape in the fourth image being aligned with the pose of the target model; using the third image, fourth image, first image, and second image to generate a plurality of control signals that govern the try-on image generation process. The control signals include both the transformed clothing information from the clothing deformation process and the original features of the item of clothing in the second image. This ensures that the generated try-on image effectively preserves the detailed features of the item of clothing and aligns more closely with the body shape and pose of the target model, enhancing the realism and fidelity of the try-on image.

Based on the above embodiments, this embodiment further provides a try-on image generation model training device, which includes the following modules:
sample image pair acquisition module: this module is configured to obtain image pairs including a sample model image and a sample clothing image, and in each image pair, the clothing in the sample model image and the sample clothing image is the same but differs in shape;
try-on image generation module: this module is configured to use the image pairs as input images for the try-on image generation model to be trained, controlling the model to generate try-on images;
iterative optimization module: this module is configured to iteratively optimize the try-on image generation model to be trained with the goal of aligning the try-on image with the sample model image, thereby obtaining a trained try-on image generation model;
wherein the process of controlling the try-on image generation model to be trained to generate try-on images includes:
performing image processing on the sample model image to obtain a plurality of model information images expressing different information;
applying clothing deformation processing to the clothing in the sample clothing image based on the sample model image to obtain a clothing deformation image, wherein in the clothing deformation image, the clothing shape aligns with the pose of the model in the sample model image;
based on the model information images, the clothing deformation image, the sample model image, and the sample clothing image, controlling the try-on image generation model to be trained to generate the try-on image.

Optionally, the process of controlling the try-on image generation model to be trained to generate the try-on image based on the model information images, the clothing deformation image, the sample model image, and the sample clothing image includes:
using the sample model image and the sample clothing image as input images for the try-on image generation model to be trained to generate a denoising control signal during the denoising process based on the sample clothing image, the model information images, and the clothing deformation image, and then, generating the try-on image through the try-on image generation model to be trained.

Optionally, the process of obtaining image pairs including sample model images and sample clothing images includes:
obtaining the first image pairs including sample model images and sample clothing images, where the sample clothing images are flat-laid clothing images;
applying clothing deformation processing to the sample clothing image in the same first image pair based on the sample model image, to obtain a clothing deformation image corresponding to the sample model image;
using the clothing deformation image as the sample clothing image, and pairing it with the corresponding sample model image, construct the second image pair;
integrating the first image pairs and the second image pairs to obtain image pairs composed of sample model images and sample clothing images.

In summary, the try-on image generation model training device disclosed in this application achieves the following: by obtaining image pairs composed of sample model images and sample clothing images, where the clothing in the same image pair is identical but varies in shape, the training dataset is expanded, which enhances the robustness of the model trained on the extended dataset against data variations; during the process of using these image pairs as input images for the try-on image generation model to be trained, and controlling the model to generate try-on images, a plurality of model information images expressing different information are obtained by processing the sample model images; clothing deformation processing is applied to the clothing in the sample clothing images based on the sample model images to obtain clothing deformation images, and in these clothing deformation images, the clothing shape is aligned with the pose of the model in the sample model images; using the model information images, clothing deformation images, sample model images, and sample clothing images as input, the try-on image generation model is controlled to generate try-on images, and these try-on images preserve the detailed features of the clothing and achieve higher alignment with the pose and body shape of the model, resulting in improved realism and quality of the try-on images.

Based on the above embodiments, this embodiment further provides a try-on image generation device, applicable to a client, which includes:
a module for obtaining the clothing image of the item of clothing to be tried on, as well as obtaining the user image of the current user in the target pose as uploaded by the user;
a module for responding to a try-on image generation operation by generating a try-on request based on the user image and the clothing image, and sending the try-on request to a preset server;
a module for obtaining the try-on image generated by the preset server in response to the try-on request, where the try-on image represents the user wearing the item of clothing to be tried on in the target pose;
a module for displaying the try-on image to the current user, where the try-on image is generated by the preset server through the following process: performing image processing on the user image to obtain a plurality of third images, each expressing different information; applying clothing deformation processing to the item of clothing in the clothing image based on the user image to obtain a fourth image, where the clothing shape in the fourth image matches the pose of the user in the user image; using the third images, the fourth image, the user image, and the clothing image to generate the try-on image.

In summary, the try-on image generation device disclosed in the embodiments of this application can generate try-on images in real time based on the user image provided by the user and the clothing image selected by the user. The try-on images preserve the detailed features of the clothing in the clothing image and ensure a closer fit between the clothing in the try-on image and the user's body shape and pose. This enhances the realism of the try-on images and significantly improves the user experience.

Based on the above embodiments, this embodiment further provides a try-on image generation device applicable to a client, which includes:
a module for obtaining the first image of the target model in the target pose selected by the current user, as well as obtaining the second image of the item of clothing to be tried on;
a module for responding to a try-on image generation operation by generating a try-on request based on the first image and the second image, and sending the try-on request to a preset server;
a module for obtaining the try-on image generated by the preset server in response to the try-on request;
a module for displaying the try-on image to the current user;
wherein the try-on image is generated by the preset server through the following process: performing image processing on the first image to obtain a plurality of third images, each expressing different information; applying clothing deformation processing to the item of clothing in the second image based on the first image to obtain a fourth image, where the clothing shape in the fourth image aligns with the pose of the target model in the first image; using the third images, the fourth image, the first image, and the second image to generate the try-on image, which depicts the target model in the specified pose wearing the item of clothing to be tried on.

In summary, the try-on image generation device disclosed in the embodiments of this application can generate try-on images in real time based on the first image selected by the user and the second image uploaded by the user. The try-on images preserve the detailed features of the clothing in the second image and ensure a closer fit between the clothing in the try-on image and the body shape and pose of the model in the first image. This enhances the realism of the try-on images and effectively improves their quality.

This application also provides a non-volatile readable storage medium. The storage medium stores one or more modules (programs), which, when applied to a device, enable the device to execute the instructions for the method steps described in the embodiments of this application.

This application further provides a computer-readable storage medium. The computer-readable storage medium stores computer-executable instructions, which, when executed by a processor, are used to implement the methods described in the embodiments of this application.

This application further provides an electronic device, which includes: a processor and a memory in communication with the processor. The memory stores computer-executable instructions, and the processor executes the instructions stored in the memory to implement the methods described in this application. In some embodiments, the electronic device may include servers, terminal devices, and other types of equipment.

This application also discloses a computer program product, which includes a computer program/computer-executable instructions. When executed by a processor in an electronic device, the computer program/computer-executable instructions implement the methods described in this application.

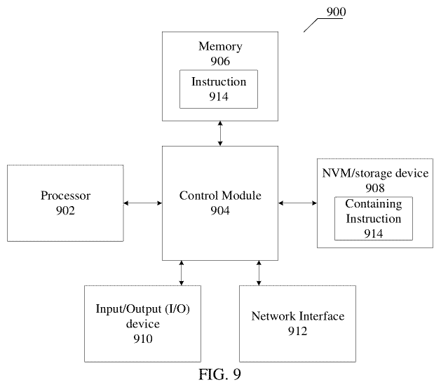

The embodiments of this disclosure can be implemented as a device configured using any suitable hardware, firmware, software, or any combination thereof. Such a device may include servers (or server clusters), terminals, and other electronic equipment. FIG. 9 schematically illustrates an exemplary device 900 that can be used to implement the various embodiments described in this application.

In one embodiment, FIG. 9 illustrates an exemplary device 900. The device includes: one or more processors 902, a control module (chipset) 904 coupled to at least one of the processors 902, a memory 906 coupled to the control module 904, a non-volatile memory (NVM)/storage device 908 coupled to the control module 904, one or more input/output (I/O) devices 910 coupled to the control module 904, and a network interface 912 coupled to the control module 904.

The processor 902 may include one or more single-core or multi-core processors, which can be a combination of general-purpose processors and/or specialized processors (e.g., graphics processors, application processors, baseband processors, etc.). In some embodiments, the device 900 can function as the server, terminal, or other equipment described in this application's embodiments.

In some embodiments, the device 900 may include one or more computer-readable media (e.g., memory 906 or NVM/storage device 908) containing instructions 914. These computer-readable media, combined with one or more processors 902 configured to execute the instructions 914, implement the modules and perform the actions described in this disclosure.

In one embodiment, the control module 904 may include any suitable interface controller to provide appropriate interfaces to at least one of the processors 902 and/or any suitable device or component communicating with the control module 904.

The control module 904 may include a memory controller module to provide an interface to the memory 906. The memory controller module can be a hardware module, a software module, and/or a firmware module.

The memory 906 can be used, for example, to load and store data and/or instructions 914 for the device 900. In one embodiment, the memory 906 may include any suitable volatile memory, such as an appropriate DRAM. In some embodiments, the memory 906 may include Double Data Rate Type 4 Synchronous Dynamic Random Access Memory (DDR4 SDRAM).

In one embodiment, the control module 904 may include one or more input/output (I/O) controllers to provide interfaces to the NVM/storage device 908 and one or more input/output devices 910.

For example, the NVM/storage device 908 can be used to store data and/or instructions 914. The NVM/storage device 908 may include any suitable non-volatile memory (e.g., flash memory) and/or one or more suitable non-volatile storage devices (e.g., one or more Hard Disk Drives (HDDs), one or more Compact Disc (CD) drives, and/or one or more Digital Versatile Disc (DVD) drives).

The NVM/storage device 908 may include storage resources that are part of the device 900 on which it is installed, or it may be accessible to the device without being part of it. For example, the NVM/storage device 908 can be accessed over a network via one or more input/output (I/O) devices 910.

One or more input/output (I/O) devices 910 can provide the device 900 with an interface for communication with other suitable devices. The I/O devices 910 may include components such as communication modules, audio components, and sensor modules. The network interface 912 provides the device 900 with an interface for communication over one or more networks. The device 900 can wirelessly communicate with one or more components of a wireless network based on any wireless network standard and/or protocol, such as Bluetooth, WiFi, 2G, 3G, 4G, 5G, or combinations thereof.

In one embodiment, at least one of the processors 902 may be logically packaged together with one or more controllers (e.g., the memory controller module) of the control module 904. In another embodiment, at least one of the processors 902 may be logically packaged together with one or more controllers of the control module 904 to form a System-in-Package (SiP). In yet another embodiment, at least one of the processors 902 may be logically integrated with one or more controllers of the control module 904 on the same die. In a further embodiment, at least one of the processors 902 may be logically integrated with one or more controllers of the control module 904 on the same die to form a System-on-Chip (SoC).

In various embodiments, the device 900 may include, but is not limited to, servers, desktop computing devices, or mobile computing devices (e.g., laptop computers, handheld computing devices, tablets, netbooks, etc.), as well as other terminal devices. In some embodiments, the device 900 may have more or fewer components and/or a different architecture. For example, in certain embodiments, the device 900 may include one or more cameras, keyboards, Liquid Crystal Display (LCD) screens (including touch screens), non-volatile memory ports, a plurality of antennas, graphics chips, Application-Specific Integrated Circuits (ASICs), and speakers.

In such a detection device, the main control chip can serve as the processor or control module. Sensor data, location information, and other data can be stored in the memory or the NVM/storage device. The sensor array can function as the input/output (I/O) devices, and the communication interface may include the network interface.

The embodiments of this application also provide an electronic device, which includes: a processor, and a memory storing executable code. When the executable code is executed, it enables the processor to perform one or more of the methods described in this application's embodiments. In the embodiments, the memory can store various types of data, such as target files, data associated with files and applications, and user behavior data, among others. This provides a data foundation for various processing tasks.

The embodiments of this application also provide one or more machine-readable media storing executable code. When the executable code is executed, it enables the processor to perform one or more of the methods described in this application's embodiments.

For the device embodiments, since they are fundamentally similar to the method embodiments, the descriptions are simplified. Relevant details can be referenced in the sections describing the method embodiments.

The embodiments in this application are described in a progressive manner. Each embodiment focuses on differences compared to other embodiments, and similar or identical parts among the embodiments can be referenced to each other.

The embodiments of this application are described with reference to the flowcharts and/or block diagrams of methods, terminal devices (systems), and computer program products according to the embodiments of this application. It should be understood that each flow and/or block in the flowcharts and/or block diagrams, as well as combinations of flows and/or blocks, can be implemented using computer program instructions. These computer program instructions can be provided to a general-purpose computer, a special-purpose computer, an embedded processor, or other programmable data processing terminal devices. The instructions, when executed by the processor of the computer or other programmable data processing terminal devices, create a machine that performs the functions specified in one or more flows of the flowcharts and/or one or more blocks of the block diagrams.

These computer program instructions can also be stored in a computer-readable storage medium that directs a computer or other programmable data processing terminal devices to operate in a specific manner. The instructions stored in the computer-readable storage medium produce an article of manufacture that includes an instruction mechanism, which implements the functions specified in one or more flows of the flowcharts and/or one or more blocks of the block diagrams.

These computer program instructions can also be loaded onto a computer or other programmable data processing terminal devices, causing the computer or terminal devices to perform a series of operational steps that produce computer-implemented processes. Consequently, the instructions executed on the computer or terminal devices provide steps for implementing the functions specified in one or more flows of the flowcharts and/or one or more blocks of the block diagrams.

Although the preferred embodiments of this application have been described, those skilled in the art, upon understanding the basic inventive concepts, may make additional changes and modifications to these embodiments. Therefore, the appended claims are intended to be construed to include the preferred embodiments as well as all changes and modifications that fall within the scope of this application.

Finally, it should be noted that relational terms such as “first” and “second” are used herein merely to distinguish one entity or operation from another entity or operation and do not necessarily require or imply any actual relationship or order between these entities or operations. Additionally, the terms “include,” “comprise,” or any of their variations are intended to encompass a non-exclusive inclusion, such that a process, method, article, or terminal device that includes a list of elements not only includes those elements but may also include other elements not explicitly listed or elements inherent to such a process, method, article, or terminal device. Without further limitations, an element defined by the phrase “including a . . . ” does not exclude the presence of additional identical elements in the process, method, article, or terminal device that includes the element.

The above provides a detailed description of a try-on image generation method, a try-on image generation system, a try-on image generation model training method, an electronic device, a storage medium, and a computer program product as disclosed in this application. Specific examples are used herein to explain the principles and embodiments of this application. The descriptions of the above embodiments are intended solely to facilitate understanding of the methods and core concepts of this application. At the same time, for those skilled in the art, modifications in specific implementations and application scopes may be made based on the ideas presented in this application. Therefore, the content of this specification should not be construed as limiting this application.

What is claimed is:

1. A method for generating a try-on image, comprising:
obtaining a first image of a target model and a second image of an item of clothing to be tried on;
performing image processing on the first image to generate a plurality of third images, each expressing different information;
performing clothing deformation processing on the item of clothing in the second image based on the first image to obtain a fourth image, wherein a clothing shape in the fourth image aligns with a pose of the target model; and
generating a try-on image of the target model wearing the item of clothing to be tried on in the target model's pose based on the third images, the fourth image, the first image, and the second image.

2. The method according to claim 1, wherein performing image processing on the first image to generate a plurality of third images expressing different information comprises:
extracting skeletal pose information from the first image to obtain a third image representing the skeletal pose of the target model in the first image; and/or
performing occlusion processing on a target image region of the first image to obtain a third image with clothing expression removed; and/or
performing masking processing on the first image to obtain a third image representing a redrawn region.

3. The method according to claim 2, wherein the target image region includes a wearing region that matches the item of clothing to be tried on.

4. The method according to claim 1, wherein performing clothing deformation processing on the item of clothing in the second image based on the first image to obtain a fourth image comprises:
obtaining a fifth image representing a skeletal pose of the target model in the first image, and a sixth image representing a body shape and pose of the target model in the first image;
performing masking processing on the item of clothing in the second image to obtain a seventh image;
using the fifth image and the sixth image as first branch inputs to a pre-trained appearance flow deformation network, and using the second image and the seventh image as second branch inputs to the appearance flow deformation network; and performing clothing deformation processing on the item of clothing to be tried on using the appearance flow deformation network to obtain the fourth image.

5. The method according to claim 1, wherein generating the try-on image of the target model wearing the item of clothing in the corresponding pose based on the third images, the fourth image, the first image, and the second image comprises:
using the first image and the second image as input images for a pre-trained try-on image generation model; generating a denoising control signal during a denoising process of the try-on image generation model based on the second image, the third images, and the fourth image; and generating the try-on image of the target model wearing the item of clothing in the corresponding pose through the try-on image generation model.

6. The method according to claim 5, wherein using the first image and the second image as input images for a pre-trained try-on image generation model, generating a denoising control signal during the denoising process based on the second image, the third images, and the fourth image, and generating the try-on image of the target model wearing the item of clothing in the corresponding pose through the try-on image generation model comprises:
performing visual feature extraction on the second image to obtain a feature vector of the item of clothing to be tried on;
applying noise addition to the first image using a noise addition module of the pre-trained try-on image generation model to generate a noisy image;
performing multi-time-step denoising on the noisy image using a generation network of the try-on image generation model to obtain latent space vectors output at each time step, wherein the multi-time-step denoising comprises: concatenating the third images, the fourth image, and the latent space vector output from a previous time step along an image channel dimension to obtain a concatenated vector; performing feature interaction between the concatenated vector and the feature vector based on an attention mechanism to obtain the latent space vector output for a current time step; and
generating the try-on image of the target model wearing the item of clothing in the corresponding pose based on the latent space vector output at a specified time step.

7. A non-transitory computer-readable storage medium configured with instructions executable by one or more processors to cause the one or more processors to perform the method of claim 1.

8. An electronic device comprising:
one or more processors; and
one or more computer-readable memories coupled to the one or more processors and having instructions stored thereon that are executable by the one or more processors to perform the method of claim 1.

9. A method for training a try-on image generation model, comprising:
obtaining an image pair including a sample model image and a sample clothing image, wherein the clothing in the sample model image and the sample clothing image within the same image pair is the same but differs in shape;
using the image pair as input images for the try-on image generation model to be trained and controlling the try-on image generation model to generate a try-on image;
iteratively optimizing the try-on image generation model to be trained with an objective of aligning the generated try-on image with the sample model image, thereby obtaining a trained try-on image generation model;
wherein controlling the try-on image generation model to be trained to generate a try-on image comprises:
performing image processing on the sample model image to obtain a plurality of model information images expressing different information;
performing clothing deformation processing on the clothing in the sample clothing image based on the sample model image to obtain a clothing deformation image, wherein a clothing shape in the clothing deformation image aligns with a pose of the model in the sample model image; and
controlling the try-on image generation model to be trained to generate the try-on image based on the model information images, the clothing deformation image, the sample model image, and the sample clothing image.

10. The method according to claim 9, wherein controlling the try-on image generation model to be trained to generate the try-on image based on the model information images, the clothing deformation image, the sample model image, and the sample clothing image comprises:
using the sample model image and the sample clothing image as input images for the try-on image generation model to be trained; generating a denoising control signal during a denoising process of the try-on image generation model based on the sample clothing image, the model information images, and the clothing deformation image; and generating the try-on image through the try-on image generation model to be trained.

11. The method according to claim 9, wherein obtaining an image pair including a sample model image and a sample clothing image comprises:
obtaining a first image pair including a sample model image and a sample clothing image, wherein the sample clothing image is a flat-laid clothing image;
performing clothing deformation processing on the sample clothing image in the same first image pair based on the sample model image to obtain a clothing deformation image corresponding to the sample model image;
using the clothing deformation image as the sample clothing image and pairing it with the corresponding sample model image to construct a second image pair; and
integrating the first image pair and the second image pair to obtain an image pair including sample model image and sample clothing image.

12. A non-transitory computer-readable storage medium configured with instructions executable by one or more processors to cause the one or more processors to perform the method of claim 9.

13. An electronic device comprising:
one or more processors; and
one or more computer-readable memories coupled to the one or more processors and having instructions stored thereon that are executable by the one or more processors to perform the method of claim 9.

14. A method for generating a try-on image, applied to a client, comprising:
obtaining a clothing image of an item of clothing to be tried on and a user image of a current user in a target pose uploaded by the user;
generating a try-on request based on the user image and the clothing image in response to a try-on image generation operation, and sending the try-on request to a preset server;
obtaining a try-on image generated by the preset server in response to the try-on request, wherein the try-on image depicts the user wearing the item of clothing to be tried on in the target pose;
displaying the try-on image to the current user, wherein the try-on image is generated by the preset server through the following process: performing image processing on the user image to generate a plurality of third images expressing different information; performing clothing deformation processing to the item of clothing in the clothing image based on the user image to obtain a fourth image, wherein a clothing shape in the fourth image matches the target pose of the user in the user image; and generating the try-on image based on the third images, the fourth image, the user image, and the clothing image.

15. The method according to claim 14, wherein performing image processing on the user image to generate a plurality of third images expressing different information comprises:
extracting skeletal pose information from the user image to obtain a third image representing the skeletal pose of the current user in the user image; and/or
performing occlusion processing on a target image region of the user image to obtain a third image with clothing expression removed; and/or
performing masking processing on the user image to obtain a third image representing a redrawn region.

16. The method according to claim 15, wherein the target image region includes a wearing region that matches the item of clothing to be tried on.

17. The method according to claim 14, wherein performing clothing deformation processing to the item of clothing in the clothing image based on the user image to obtain a fourth image comprises:
obtaining a fifth image representing a skeletal pose of the current user in the user image, and a sixth image representing a body shape and target pose of the current user in the user image;
performing masking processing on the item of clothing in the clothing image to obtain a seventh image;
using the fifth image and the sixth image as first branch inputs to a pre-trained appearance flow deformation network, and using the clothing image and the seventh image as second branch inputs to the appearance flow deformation network; and performing clothing deformation processing on the item of clothing to be tried on using the appearance flow deformation network to obtain the fourth image.

18. The method according to claim 14, wherein generating the try-on image based on the third images, the fourth image, the user image, and the clothing image:
using the clothing image and the user image as input images for a pre-trained try-on image generation model; generating a denoising control signal during a denoising process of the try-on image generation model based on the clothing image, the third images, and the fourth image; and generating the try-on image of the current user wearing the item of clothing in the target pose through the try-on image generation model.

19. The method according to claim 18, wherein using the clothing image and the user image as input images for a pre-trained try-on image generation model, generating a denoising control signal during the denoising process based on the clothing image, the third images, and the fourth image, and generating the try-on image of the current user wearing the item of clothing in the target pose through the try-on image generation model comprises:
performing visual feature extraction on the clothing image to obtain a feature vector of the item of clothing to be tried on;
applying noise addition to the user image using a noise addition module of the pre-trained try-on image generation model to generate a noisy image;
performing multi-time-step denoising on the noisy image using a generation network of the try-on image generation model to obtain latent space vectors output at each time step, wherein the multi-time-step denoising comprises: concatenating the third images, the fourth image, and the latent space vector output from a previous time step along an image channel dimension to obtain a concatenated vector; performing feature interaction between the concatenated vector and the feature vector based on an attention mechanism to obtain the latent space vector output for a current time step; and
generating the try-on image of the current user wearing the item of clothing in the target pose based on the latent space vector output at a specified time step.

20. A non-transitory computer-readable storage medium configured with instructions executable by one or more processors to cause the one or more processors to perform the method of claim 14.
